(19) United States
(12) Patent Application Publication
(10) Pub. No.: US 2024/0272233 A1
(43) Pub. Date: Aug. 15, 2024

(54) METHOD FOR PREDICTING AN AGING STATE OF AN ELECTRICAL ENERGY STORAGE UNIT

(71) Applicant: Robert Bosch GmbH, Stuttgart (DE)

(72) Inventors: Raimund Kaiser, Ditzingen (DE); Bahos Kaky, Stuttgart (DE); Calvin Pfob, Stuttgart (DE)

(21) Appl. No.: 18/439,450

(22) Filed: Feb. 12, 2024

(30) Foreign Application Priority Data
Feb. 15, 2023 (DE) 10 2023 201 271.5

(51) Int. Cl. G01R 31/392; G01R 31/367; G01R 31/388; G01R 31/396

(52) U.S. Cl. CPC G01R 31/392; G01R 31/367; G01R 31/388; G01R 31/396

(57) ABSTRACT

A method for predicting an aging state of an electrical energy storage unit. In one example, the method includes providing a first mathematical model having first input variables to evaluate factors influencing the aging of the electric energy storage unit; providing a second mathematical model having second input variables to determine the aging state of the electrical energy storage unit; and combine the first mathematical model and the second mathematical model by means of a neural network into a third mathematical model in order to predict the aging state of the electrical energy storage unit.

### BACKGROUND

The present invention proceeds from a method for predicting an aging state of an electrical energy storage unit.

Electrical energy storage units, in particular in the form of rechargeable batteries or battery cells, are becoming increasingly popular as energy storage means in a wide range of fields, from consumer electronics to the automotive sector. However, electrical energy storage units are subject to aging processes that lead to a reduction in electrical power and storage capacity over their service life. Characteristic variables for the aging state of a battery include the state of health of the capacity—SoHC—as well as the internal resistance—SoHR.

Given that these variables have a direct impact on the system data and meet the requirements of the electrical energy storage unit, a determination as well as prediction of this is of utmost relevance for end-users as well as fleet operators, but also for automobile manufacturers. For example, the SoHC of a battery used in an automobile has a direct impact on the possible range, while the SoHR significantly affects the maximum possible charging and discharging capacity. Given that these variables are typically only measured at certain operating points, e.g., a predefined charging area, it may be necessary to estimate the current values based on past measurements. As part of predictive maintenance and determining the residual financial value of a battery, accurate prediction of the SoHC and SoHR is becoming increasingly relevant. They directly determine the provisions required for likely replacements or warranty claims by insurers, battery manufacturers, OEMs, fleet operators, and end users. Furthermore, precisely predicting the SoHC and SoHR can be used to extend the service life of the battery by preventively restricting system data or adjusting the charging strategy so that excessive aging does not occur in a short time.

This prediction of SoHC and SoHR is performed either in an embedded battery management system-BMS-or in a cloud environment, e.g., with Battery-in-the-Cloud. In this context, the most common method is to assume linear aging as a function of time and capacity and energy throughput. This linear methodology typically requires little effort to create the algorithms, calibration, and computational time, and provides acceptable results over a shorter prediction period. Due to non-linear aging processes, this method is only suitable for precise prediction to a limited extent, especially for larger prediction time periods.

Publication WO 2022/101769 discloses a system for estimating the state of charge of a battery by means of neural networks.

Publication US 2019/064283 discloses a method for determining the state of health of a battery.

### SUMMARY

Disclosed is a method for predicting an aging state of an electrical energy storage unit having the features of the disclosure.

A first mathematical model is provided thereby. The first mathematical model comprises first input variables for evaluating factors influencing the aging of the electric energy storage unit.

Further provided is a second mathematical model. The second mathematical model comprises second input variables suitable for determining the aging state of the electrical energy storage unit.

The first mathematical mode and the second mathematical mode are then combined by means of a neural network into a third mathematical model in order to predict the aging state of the electrical energy storage unit.

This is advantageous because the third mathematical model thus enables a higher accuracy in the prediction than with comparable approaches, in particular due to the non-linear aging processes, and furthermore non-linear and not explicitly modeled relationships between usage and degradation are taken into account for a higher predictive accuracy. In addition, sudden severe degradation processes in the SoHC are correctly mapped in the third mathematical model if there is a sufficient amount of data.

In particular, the electrical energy storage unit is designed as a battery cell or battery having a plurality of battery cells, and the method is implemented in a computer-implemented manner.

The method according to the invention advantageously comprises predicting the aging state of the electrical energy storage unit using the third mathematical model. This is advantageous for deriving a “predictive maintenance” replacement recommendation to provide the end-user with sufficient range or to suggest or enforce the recommendation for a change in the conditions of use of the electrical energy storage units to increase the service life of the battery.

The first input variables of the first mathematical model are advantageously in the form of multi-dimensional histograms. This is advantageous because the required amount of data is reduced without significant loss of information for holistic aging and use, and thus also enables use on a controller with limited memory availability. This is of great importance, especially in the automotive sector, as well as for electrically assisted bicycles and battery-powered tools.

Advantageously, the method extracts histogram information while taking into account domain knowledge about the causes of aging of an electrical energy storage unit as first input variables for the first mathematical model by means of, e.g., an evaluation derived from data and domain knowledge, which reduces multi-dimensional histograms to scalar values, whereby the scale value correlates with the aging of the battery. Alternatively or additionally, histogram information is combined into scalar statistical variables as first input variables for the first mathematical model, e.g., as a median, mean, or standard deviation. This is advantageous in order to avoid possible over-adjustment of a neural network and to enable advantageous pattern recognition.

The second mathematical model advantageously comprises a further neural network featuring a memory function. It is advantageous to use neural networks featuring a memory function (referred to as Recurrent Neural Networks, e.g., having LSTM cells) in order to enable the neural network to take into account the time series of SoHC/SoHR whose historical values are input variables and future values are target variables. Given that the sequential capacity throughput/current integral also correlates very strongly with cyclic aging, it is advantageous to consider it as a time series to be able to take any changes in use into account.

Data of the first input variables of the first mathematical model and data of the second input variables of the second mathematical model are advantageously provided. The third mathematical model, comprising the first and second mathematical models, is thus trained to optimize the prediction of the aging state, i.e., with the data of the first input variables and the second input variables, whereby the second input variables can also be output variables of the third mathematical model. For example, the historical development of the aging state of the electrical energy storage unit, comprising the health state of the capacity and/or the internal resistance, can be used as both input and output variables of the third mathematical model, obviously adjusted over time in each case. This is advantageous because the model is continuously improving by taking into account path-dependent aging effects and adapting to new usage profiles and operating conditions.

The input variables of the first mathematical model advantageously include an electrical voltage of the electrical energy storage unit, an electrical current of the electrical energy storage unit, a temperature of the electrical energy storage unit and/or a state of charge of the electrical energy storage unit, and/or the input variables of the second mathematical model include a state of health of the capacity and/or the internal resistance. This is advantageous because the corresponding variables that are generated or measured when operating an electrical energy storage unit in any case are used for prediction and therefore no additional effort is required.

The data of the first input variables of the first mathematical model and/or the data of the second input variables of the second mathematical model are advantageously stored in a first data storage means, and the stored data are transmitted to a second data storage means physically located at another location. This is advantageous in order to have the ability to continuously improve the method during operation and to use fleet data profitably by enabling the mathematical models to be continuously updated by means of training and to adapt them to changed or use new usage profiles or operating conditions.

A further object of the invention is a device for predicting an aging state of an electrical energy storage unit comprising at least one electronic computing unit configured to perform the method steps according to the invention. The advantages specified hereinabove can be achieved as a result.

A further object of the invention is a computer program comprising instructions that prompt the device according to the invention to perform all of the method steps according to the invention. The advantages specified hereinabove can be achieved as a result.

A further object of the invention is a machine-readable storage medium on which the computer program is stored. The advantages specified hereinabove can be achieved as a result.

### BRIEF DESCRIPTION OF THE DRAWINGS

Advantageous embodiments of the invention are illustrated in the drawings and explained in more detail in the subsequent description.

Shown are:

FIG. 1 a flow chart of a first embodiment of the method according to the invention;

FIG. 2 a flow chart of a second embodiment of the method according to the invention;

FIG. 3 a schematic illustration of one embodiment of a device according to the invention according to a first embodiment;

FIG. 4 a schematic illustration of an evaluation function for extracting histogram information while taking into account domain knowledge about the causes of aging of an electrical energy storage unit.

### DETAILED DESCRIPTION

In all of the drawings, identical reference characters denote identical apparatus components or identical method steps.

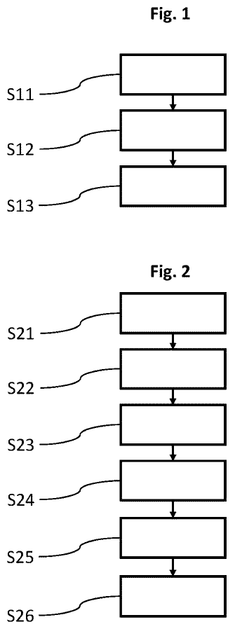

FIG. 1 shows a flow chart of a method according to the invention for predicting an aging state of an electrical energy storage unit according to a first embodiment. In a first step S11, a first mathematical model having first input variables for evaluating factors influencing the aging of the electric energy storage unit is provided.

The first input variables can include an electrical voltage of the electrical energy storage unit, an electrical current of the electrical energy storage unit, a temperature of the electrical energy storage unit, and/or a state of charge of the electrical energy storage unit, or their chronological progression. The first input variables can also be in the form of multi-dimensional histograms. The second input variables of the second mathematical model can include an aging state of the electrical energy storage unit, e.g., a state of health of the capacity and/or the internal resistance.

In a second step S12, a second mathematical model having second input variables is provided in order to determine the aging state of the electrical energy storage unit. The second mathematical model can comprise a neural network featuring a memory function.

In a third step S13, the first mathematical mode and the second mathematical mode are combined by means of a neural network into a third mathematical model in order to predict the aging state of the electrical energy storage unit. It is thereby possible to predict the aging state of the electrical energy storage unit using the third mathematical model.

FIG. 2 shows a flow chart of a method according to the invention for predicting an aging state of an electrical energy storage unit according to a second embodiment.

In a first step S21, a first mathematical model with first input variables for evaluating factors influencing the aging of the electrical energy storage unit is provided in an electronic computing unit, e.g., a controller in a vehicle having an electrical energy storage unit.

In a second step S22, which can also run in parallel with the first step, a second mathematical model having second input variables is provided in order to determine the aging state of the electrical energy storage unit. The second mathematical model can, e.g., comprise an evaluation function derived from data and domain knowledge that reduces multi-dimensional histograms to scalar values, whereby the scalar value correlates with the aging of the battery. The evaluation function can, e.g., be described as in FIG. 4.

In a third step S23, data for the first input variables of the first mathematical model are provided as histograms and data for the second input variables of the second mathematical model.

In a fourth step S24, histogram information is extracted from the histogram data for the first input variables while taking into account domain knowledge about the causes of aging of an electrical energy storage unit as first input variables for the first mathematical model.

In a fifth step S25, the first mathematical mode and the second mathematical mode are combined by means of a neural network into a third mathematical model in order to predict the aging state of the electrical energy storage unit.

In a sixth step S26, the aging state of the electrical energy storage unit is predicted by the third mathematical model utilizing the first input variables of the first mathematical model and the second input variables of the second mathematical model, i.e., the development of the aging state is predicted for a certain future period of time.

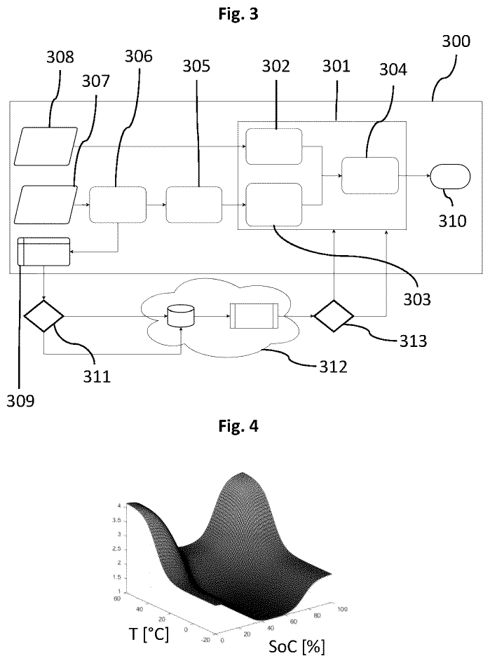

FIG. 3 shows a schematic illustration of a device 300 according to the invention for predicting an aging state of an electrical energy storage unit according to a first embodiment. The corresponding method steps are modeled in different functional blocks which can, e.g., be implemented in an electronic computing unit and are therefore computer-implemented.

A first functional block 301 comprises a second functional block 302, which implements a first mathematical model with first input variables for evaluating factors influencing the aging of the electrical energy storage unit.

The first functional block 301 further comprises a third functional block 303, which implements a second mathematical model with second input variables in order to determine the aging state of the electrical energy storage unit.

The first functional block 301 further comprises a third functional block 304, which combines the first mathematical mode and the second mathematical mode by means of a neural network into a third mathematical model in order to predict the aging state of the electrical energy storage unit.

In a seventh functional block 307, data are provided for the first input variables, which can, e.g., include current, voltage, state of charge, and temperature of the electrical energy storage unit. In a sixth functional block 306, histograms are formed from these data and, in a fifth functional block 305, a dimensional reduction of these histograms is, e.g., performed by extracting histogram information while taking into account domain knowledge about the causes of aging of the electrical energy storage unit as first input variables for the first mathematical model and/or by combining histogram information into scalar statistical quantities as first input variables for the first mathematical model.

In an eighth functional block 308, data on the aging state of the electrical energy storage unit, including, e.g., data on the state of health of the capacity, the internal resistance, and/or the charge flow rate of the electrical energy storage unit are provided.

In a ninth functional block 309, a first data storage means is provided for storing the data of the first input variables of the first mathematical model and/or the data of the second input variables of the second mathematical model.

In a tenth functional block 310, the predicted aging state of the electrical energy storage unit is provided. The predicted state of aging can include a prediction of the health state of the capacity and/or the internal resistance of the electrical energy storage unit.

In an eleventh functional block 311, which can also be arranged outside of the device 300, it is verified whether a data connection to a cloud system 312 exists. If yes, the data are continuously transferred to the cloud system 312. If not, the data are, e.g., transferred during a workshop visit. In the cloud system 312, the data are stored in a database and used to train the third mathematical model in the cloud system, in order to perform optimization there if necessary. Furthermore, a functional block 313 verifies whether the data connection still exists. If there is still a data connection between the device 300 and the cloud system 312, then the third mathematical model can be updated continuously within the first functional block 301. If not, an update is optionally made during a workshop visit.

FIG. 4 shows a schematic illustration of an evaluation function for extracting histogram information while taking into account domain knowledge about the causes of aging of an electrical energy storage unit, and a temperature of the electrical energy storage unit is plotted on a first axis T. A charging state of the electrical energy storage unit is plotted on a second axis SoC. These two variables result in a scalar value depicted on the third axis. This evaluation function can, e.g., be applied to the entire histogram by multiplication, resulting in said scalar value. This is advantageous because all observed extreme states-and in particular extreme states that are particularly relevant for aging-are therefore taken into account for a prediction. A large amount of data can therefore also be processed while maintaining a high level of information content.

1. A method for predicting an aging state of an electrical energy storage unit, the method comprising the following steps:
providing a first mathematical model having first input variables in order to evaluate factors influencing the aging of the electric energy storage unit;
providing a second mathematical model having second input variables in order to determine the aging state of the electrical energy storage unit;
combining the first mathematical model and the second mathematical model by means of a neural network into a third mathematical model in order to predict the aging state of the electrical energy storage unit.

2. The method according to claim 1, further comprising:
predicting the aging state of the electrical energy storage unit using the third mathematical model.

3. The method according to claim 1, wherein the first input variables of the first mathematical model are in the form of multi-dimensional histograms.

4. The method according to claim 3, further comprising at least one of the following steps:
extracting histogram information while taking into account domain knowledge about the causes of aging of an electrical energy storage unit as first input variables for the first mathematical model;
combining histogram information into scalar statistical variables as first input variables quantities for the first mathematical model.

5. The method according to claim 1, wherein the second mathematical model comprises a further neural network featuring a memory function.

6. The method according to claim 1, further comprising:
providing data of the first input variables of the first mathematical model and data of the second input variables of the second mathematical model;
training the third mathematical model comprising the first and the second mathematical models in order to optimize the prediction of the aging state using the data of the first input variables and the second ones.

7. The method according to claim 1, wherein the first input variables of the first mathematical model include an electrical voltage of the electrical energy storage unit, an electrical current of the electrical energy storage unit, a temperature of the electrical energy storage unit, and/or a state of charge of the electrical energy storage unit, and/or wherein the second input variables of the second mathematical model include a state of health of the capacity and/or the internal resistance.

8. The method according to claim 7, comprising:
saving data of the first input variables of the first mathematical model and/or data of the second input variables of the second mathematical model in a first data storage means;
transmitting the stored data to a second data storage means physically located at another location.

9. A device for predicting an aging state of an electrical energy storage unit comprising at least one electronic computing unit configured to provide a first mathematical model having first input variables in order to evaluate factors influencing the aging of the electric energy storage unit;
provide a second mathematical model having second input variables in order to determine the aging state of the electrical energy storage unit; and
combine the first mathematical model and the second mathematical model by means of a neural network into a third mathematical model in order to predict the aging state of the electrical energy storage unit.

10. A non-transitory, computer-readable storage medium containing instructions that when executed on a computer cause the computer to provide a first mathematical model having first input variables in order to evaluate factors influencing the aging of the electric energy storage unit;
provide a second mathematical model having second input variables in order to determine the aging state of the electrical energy storage unit; and
combine the first mathematical model and the second mathematical model by means of a neural network into a third mathematical model in order to predict the aging state of the electrical energy storage unit.
